(19) United States
(12) Patent Application Publication
(10) Pub. No.: US 2026/0234436 A1
(43) Pub. Date: Aug. 13, 2026

(54) ANTI-GLARE PROTECTIVE FILM AND OPTICAL ARTICLE INCLUDING THE SAME

(71) Applicant: ELECTRONICS AND TELECOMMUNICATIONS RESEARCH INSTITUTE, Daejeon (KR)

(72) Inventor: Woo Seok YANG, Daejeon (KR)

(21) Appl. No.: 19/533,945

(22) Filed: Feb. 9, 2026

(30) Foreign Application Priority Data
Feb. 12, 2025 (KR) 10-2025-0018238
Feb. 2, 2026 (KR) 10-2026-0020843

(51) Int. Cl. C09D 175/12; C08G 18/46; C08G 18/79; C08K 9/06; C09D 7/40; C09D 7/62

(52) U.S. Cl. CPC C09D 175/12; C08G 18/4623; C08G 18/791; C08G 18/792; C08G 18/798; C09D 7/62; C09D 7/70; C08K 9/06

(57) ABSTRACT

Provided is a protective film including a substrate including a first surface and a second surface opposing each other, and a film portion on the first surface, wherein the film portion includes an organic compound including an aliphatic polyisocyanate, and a first particle dispersed in the organic compound, wherein the first particle includes a first hollow particle having an outer radius of about 125 nm to about 250 nm, and a first coupling compound disposed on the surface of the first hollow particle, and having a secondary amine or imine group, wherein the first particle and the organic compound are bonded through a urea reaction between the secondary amine or imine group and an isocyanate group.

### CROSS-REFERENCE TO RELATED APPLICATIONS

This U.S. non-provisional patent application claims priority under 35 U.S.C. § 119 of Korean Patent Application Nos. 10-2025-0018238, filed on Feb. 12, 2025, and 10-2026-0020843, filed on Feb. 2, 2026 the entire contents of which are hereby incorporated by reference.

### BACKGROUND

### 1. Field of the Invention

An anti-glare protective film for an optical article is required to protect a display unit of the optical article from external impacts, and also prevent glare even under a strong external light source so as to allow a clear image to be conveyed in a visually comfortable way. Therefore, in order for the optical article to have improved performance, the anti-glare protective film is required to have excellent optical properties of high visible-light transmittance, high haze, and low sparkling. In addition, in order for the optical article to have improved lifespan and for the anti-glare protective film to be applicable to flexible optical articles such as a flexible display, the anti-glare protective film is also required to have mechanical properties of high hardness, high tensile strength, and high elongation.

### 2. Description of Related Art

Anti-glare protective films may be classified into those that use surface scattering caused by the surface roughness of the film and those that use volume scattering caused by light scattering particles mixed within the film. The latter has an advantage of having lower sparkling than the former. Volume scattering-based anti-glare protective films may be further classified into those that use organic particles and those that use inorganic particles for light scattering. The latter is more advantageous in improving surface hardness and tensile strength than the former. For this reason, an anti-glare protective film based on a composite, in which light scattering silica particles are dispersed as fillers in a polymer matrix, has been developed.

However, typical anti-glare protective films for optical articles, the anti-glare protective films based on silica particles and polymer composites, fail to provide both excellent optical properties and excellent mechanical properties. A protective film having high visible-light transmittance, low sparkling, and excellent mechanical properties has a limitation of having low haze for anti-glare performance. On the other hand, a film with high haze has limitations of having high sparkling and low mechanical properties.

### SUMMARY

The present disclosure provides an anti-glare protective film for an optical article, wherein the anti-glare protective film provides both excellent optical properties (high visible-light transmittance, high haze, and low sparkling) and excellent mechanical properties (high surface hardness, high tensile strength, and high elongation).

An embodiment of the inventive concept provides a protective film including a substrate including a first surface and a second surface opposing each other, and a film portion on the first surface, wherein the film portion includes an organic compound including an aliphatic polyisocyanate, and a first particle dispersed in the organic compound, wherein the first particle includes a first hollow particle having an outer radius of about 125 nm to about 250 nm, and a first coupling compound disposed on the surface of the first hollow particle, and having a secondary amine or imine group, wherein the first particle and the organic compound are bonded through a urea reaction between the secondary amine or imine group and an isocyanate group.

In an embodiment of the inventive concept, a protective film includes a substrate including a first surface and a second surface opposing each other, and a film portion on the first surface, wherein the film portion includes an organic compound including an aliphatic polyisocyanate, and a first particle and a second particle dispersed in the organic compound, wherein the first particle includes a first hollow particle having an outer radius of about 125 nm to about 250 nm, and a first coupling compound disposed on the surface of the first hollow particle, and having a secondary amine or imine group, wherein the second particle includes a second hollow particle having an outer radius of about 30 nm to about 60 nm, and a second coupling compound disposed on the surface of the second hollow particle, and having a secondary amine or imine group, wherein the first particle and the second particle and the organic compound are bonded through a urea reaction between the secondary amine or imine group and an isocyanate group, and the film portion has a thickness of about 1 μm to about 7 μm.

In an embodiment of the inventive concept, a protective film includes a substrate including a first surface and a second surface opposing each other, a film portion on the first surface, a first shock absorbing layer disposed on the first surface of the substrate, and interposed between the film portion and the substrate; and a second shock absorbing layer on the second surface of the substrate, wherein the film portion includes an organic compound including an aliphatic polyisocyanate, and a first particle dispersed in the organic compound, wherein the first particle includes a first hollow particle having an outer radius of about 125 nm to about 250 nm, and a first coupling compound disposed on the surface of the first hollow particle, and having a secondary amine or imine group, wherein the first particle and the organic compound are bonded through a urea reaction between the secondary amine or imine group and an isocyanate group.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a cross-sectional view of a protective film according to an embodiment of the inventive concept;

FIG. 2 is an enlarged view of M of FIG. 1;

FIG. 3 is a cross-sectional view of a protective film according to an embodiment of the inventive concept; and

FIG. 4 to FIG. 6 are flowcharts showing a method for manufacturing a protective film according to an embodiment of the inventive concept.

### DETAILED DESCRIPTION OF THE INVENTION

In order to facilitate sufficient understanding of the configuration and effects of the inventive concept, preferred embodiments of the inventive concept will be described with reference to the accompanying drawings. However, the inventive concept is not limited to the embodiments set forth below, and may be embodied in various forms and modified in many alternate forms. Rather, these embodiments are provided such that the disclosure of the inventive concept will be thorough and complete, and will fully convey the scope of the inventive concept to those skilled in the art to which the inventive concept pertains. In the accompanying drawings, elements are illustrated enlarged from the actual size thereof for convenience of description, and the ratio of each element may be exaggerated or reduced.

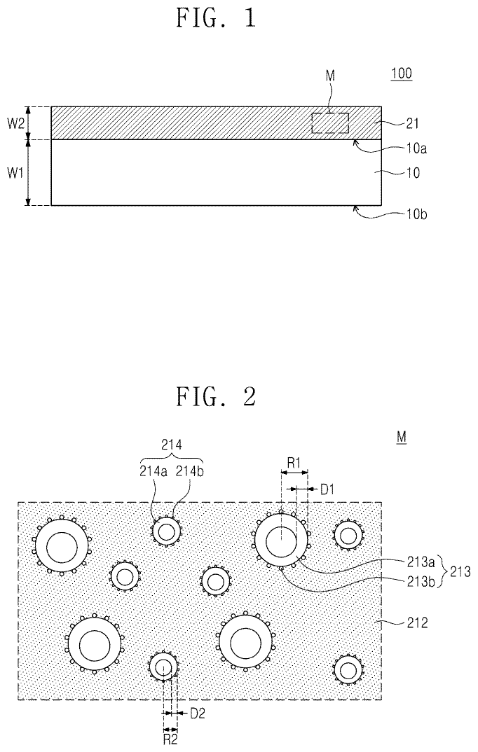

FIG. 1 is a cross-sectional view of a protective film according to an embodiment of the inventive concept. FIG. 2 is an enlarged view of M of FIG. 1.

Referring to FIG. 1, a protective film 100 according to an embodiment of the inventive concept may include a substrate 10 and a film portion 21. The film portion 21 may be disposed on the substrate 10. The substrate 10 may include a first surface 10a and a second surface 10b opposing each other. The film portion 21 may be disposed on the first surface 10a of the substrate 10.

The substrate 10 may include at least one of a cover window, an optical window, or an optical lens. The substrate 10 may include a polymer, and the polymer may be transparent. The substrate 10 may include at least one of polyethylene terephthalate, colorless polyimide, thermoplastic polyurethane, polycarbonate, or polymethyl methacrylate. The substrate 10 may have excellent impact resistance. The surface hardness (scratch resistance performance) of the substrate 10 may be a pencil hardness of about H or lower. The substrate 10 may have a thickness W1 of about 50 μm to about 150 μm.

If the surface hardness of the substrate 10 is a pencil hardness of about H, the surface hardness of the film portion 21 may be a pencil hardness of about 2 H or higher, or may be a pencil hardness of about 2 H or about 3 H. The total light transmittance of the film portion 21 may have an average value of 90% or higher in a visible-light band, i.e., a band with an optical wavelength of about 380 nm to about 780 nm.

The film portion 21 may have a thickness W2 of about 1 μm to about 7 μm. The thickness W2 of the film portion 21 may be determined according to the surface hardness of the substrate 10, and as the surface hardness of the substrate 10 decreases, the thickness of the film portion 21 may increase in order to improve the surface hardness.

The film portion 21 may include an organic compound 212 and a first particle 213. The organic compound 212 may be provided in a matrix form, and the first particle 213 may be dispersed in the organic compound 212. The organic compound 212 may cover the first particle 213 and may connect a plurality of first particles 213 to each other. The organic compound 212 may include an aliphatic polyisocyanate. Unlike an aromatic polyisocyanate, the aliphatic polyisocyanate included in the organic compound 212 may prevent yellowing or chalking caused by exposure to ultraviolet rays, and may maintain high visible-light transmittance even after long-term use.

The aliphatic polyisocyanate may include an oligomer of hexamethylene diisocyanate. The aliphatic polyisocyanate may include at least one of an isocyanurate, a compound represented by Formula 1 below, a biuret, a compound represented by Formula 2 below, and a uretdione, a compound represented by Formula 3 below.

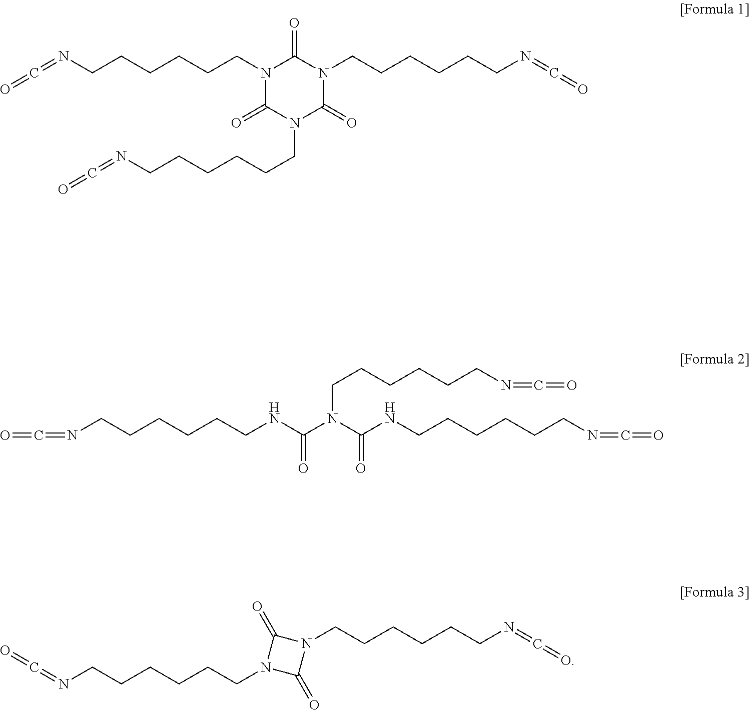 [SMILES: O=C=NCCCCCCn1c(=O)n(CCCCCCN=C=O)c(=O)n(CCCCCCN=C=O)c1=O ; O=C=NCCCCCCNC(=O)N(CCCCCCN=C=O)C(=O)NCCCCCCN=C=O ; O=C=NCCCCCCN1C(=O)N(CCCCCCN=C=O)C1=O]

The first particle 213 may be dispersed in the organic compound 212, and may be dispersed as a filler. The first particle 213 may include a first hollow particle 213a and a first coupling compound 213b disposed on the surface of the first hollow particle 213a. The first hollow particle 213a may include hollow silica. The first hollow particle 213a may be spherical, and may have an outer radius R1 of about 125 nm to about 250 nm and a shell thickness D1 of about 20 nm to about 50 nm. The shell may refer to a portion excluding the hollow in the first hollow particle 213a. If the outer radius R1 and the shell thickness D1 of the first hollow particle 213a are less than the above-described numerical ranges, haze may decrease, and if greater than the numerical ranges, visible-light transmittance may decrease.

The first hollow particle 213a may have a content of about 2 wt % to about 10 wt % based on 100 wt % of the film portion 21. If the content of the first hollow particle 213a is less than 2 wt %, haze and surface hardness may decrease. If the content of the first hollow particle 213a is greater than 10 wt %, visible-light transmittance and elongation may decrease, and sparkling may increase.

The first coupling compound 213b may be distributed on the surface of the first hollow particle 213a. The first coupling compound 213b may be a silane coupling agent. The first hollow particle 213a and the first coupling compound 213b may have a weight ratio of 1:2 to 1:10. If the weight ratio is less than the corresponding numerical range, dispersibility of the first particle 213 in the organic compound 212 may decrease, and sparking caused by agglomeration of the first particles 213 may increase. If the weight ratio is greater than the corresponding numerical range, there may be an excess of the first coupling compound 213b not attached to the surface of the first hollow particle 213a in the organic compound 212, thereby degrading mechanical properties of the film portion 21.

The first particle 213 and the organic compound 212 may be chemically bonded. The bonding may be achieved through a urea reaction between a secondary amine or imine group of the first coupling compound 213b and an isocyanate group of the aliphatic polyisocyanate of the organic compound 212.

The first coupling compound 213b may include a secondary amine (—NH) or imine (—C═N) group. Since the first coupling compound 213b includes the secondary amine or imine group, thereby achieving an appropriate urea reaction with the isocyanate (—NCO) group of the aliphatic polyisocyanate in the organic compound 212, the film portion 21 may be effectively coated in a uniform thickness on the first surface 10a of the substrate 10. If the first coupling compound 213b includes a tertiary amine (—N) group, the energy of the urea reaction is too low, thereby making it almost impossible to coat the film portion 21, and if the same includes a primary amine (—NH₂) group, the speed of the urea reaction is too fast, thereby allowing premature curing in a step of forming a composition for coating.

The —NH or —C═N group of the first coupling compound 213b and the —NCO group of the aliphatic polyisocyanate of the organic compound 212 may have an equivalent ratio of 1:1 to 1:1.2. If the equivalent ratio does not satisfy the corresponding numerical range, mechanical properties of the film portion 21 may be degraded.

The first coupling compound 213b may include N-ethyl-3-trimethoxysilyl-2-methylpropanamine represented by Formula 4 below or N-(3-(triethoxysilyl)propyl) benzaldehyde imine represented by Formula 5 below.

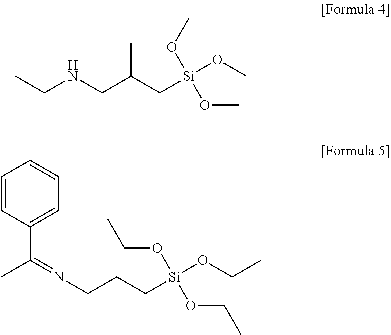

The film portion 21 may further include a second particle 214 having a smaller size than the first particle 213. The second particle 214 may be dispersed in the organic compound 212. The organic compound 212 may cover the second particle 214 and may connect a plurality of second particles 214 to each other. The second particle 214 may include a second hollow particle 214a and a second coupling compound 214b disposed on the surface of the second particle 214. The second hollow particle 214a may be spherical, and the second hollow particle 214a may have an outer radius R2 smaller than the outer radius R1 of the first hollow particle 213a. The second hollow particle 214a may include hollow silica. The second hollow particle 214a may have an outer radius R2 of about 30 nm to about 60 nm and a shell thickness D2 of about 10 nm to about 20 nm. The shell may refer to a portion excluding the hollow in the second hollow particle 214a. If the outer radius R2 and the shell thickness D2 of the second hollow particle 214a are less than the above-described numerical ranges, an effect of improving surface hardness may be degraded, and if greater than the numerical ranges, an effect of improving dispersibility of the second particle 214 and a resulting effect of suppressing sparking may be degraded. The second coupling compound 214b may include an —NH or —C═N group. That is, the second coupling compound 214b may include substantially the same material as the first coupling compound 213b.

The first hollow particle 213a and the second hollow particle 214a may have a weight ratio of 1:1 to 1:3. If the weight ratio is less than the above-described numerical range, an effect of improving dispersibility of the first particle 213 and resulting effects of suppressing sparking and improving surface hardness may be degraded. If the weight ratio is greater than the corresponding numerical range, elongation of the protective film 21 may decrease.

The second hollow particle 214a and the second coupling compound 214b may have a weight ratio of 1:0.4 to 1:1.1. If the weight ratio is less than the corresponding numerical range, an effect of improving dispersibility of the second particle 214 and a resulting effect of suppressing sparking may be degraded. If the weight ratio is greater than the corresponding numerical range, there may be an excess of the second coupling compound 214b not attached to the surface of the second hollow particle 214a in the organic compound 212, thereby degrading mechanical properties of the film portion 21. If the second particle 214 is further included, the effect of improving dispersibility of the first particle 213 and the resulting effects of suppressing sparking and improving surface hardness may be provided.

The organic compound 212 may further include a polyaspartic ester. The —NH or —C═N group in the first and second coupling compounds 213b and 214b and in the polyaspartic ester of the organic compound 212 and the —NCO group of the aliphatic polyisocyanate may have an equivalent ratio of 1:1 to 1:1.2. If the equivalent ratio does not satisfy the above-described numerical range, mechanical properties of the film portion 21 may be degraded.

The polyaspartic ester may include at least one of aspartic acid, N,N′-(methylenedi-4,1-cyclohexanediyl)bis-, tetraethyl ester represented by Formula 6 below and aspartic acid, N,N-methylenebis(2-methyl-4,1-cyclohexanediyl) bis-, tetraethyl ester represented by Formula 7 below.

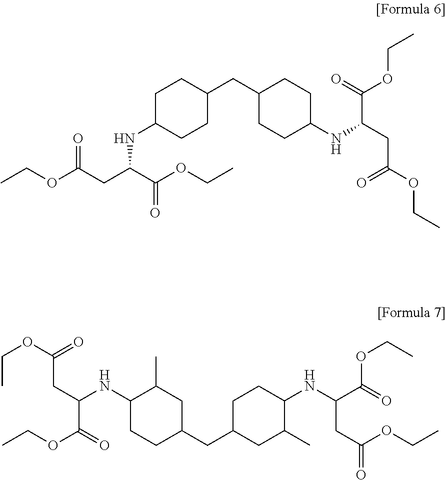

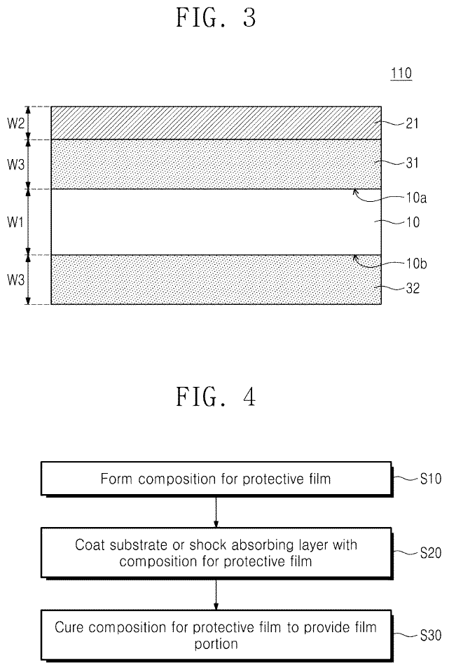

FIG. 3 is a cross-sectional view of a protective film according to an embodiment of the inventive concept. For simplicity of description, the descriptions provided with reference to FIG. 1 and FIG. 2 will be omitted.

Referring to FIG. 3, a protective film 110 according to an embodiment of the inventive concept may further include a first shock absorbing layer 31 and a second shock absorbing layer 32. The first shock absorbing layer 31 may be disposed between a substrate 10 and a film portion 21, i.e., on a first surface 10a of the substrate 10. The second shock absorbing layer 32 may be disposed on a second surface 10b of the substrate 10.

The first and second shock absorbing layers 31 and 32 may be introduced when the substrate 10 has excellent scratch resistance but has poor impact resistance. As an example, if the substrate 10 is ultra-thin glass (UTG) manufactured by performing chamfering and chemical strengthening treatments on glass, the substrate 10 may have a pencil hardness of about 9 H, but may be vulnerable to impact. The shock absorbing layers 31 and 32 may decrease surface hardness for the scratch resistance of the substrate 10 but may significantly improve tensile strength for the impact resistance. As an example, if the first shock absorbing layer 31 and the second shock absorbing layer 32 are provided on an ultra-thin glass substrate, the pencil hardness may be decreased to about 3 H or less, but the pen drop height (impact resistance) may be increased by 5 to 10 times. The film portion 21 may be disposed above the first surface 10a of the substrate 10 facing a strong external light source such as sunlight, i.e., on the first shock absorbing layer 31. The description of the film portion 21 is the same as that provided with reference to FIG. 1 and FIG. 2.

The first shock absorbing layer 31 and the second shock absorbing layer 32 may each have a thickness W3 of about 30 μm to about 60 μm. If the thickness W3 of each of the shock absorbing layers 31 and 32 is less than about 30 μm, impact resistance may be degraded. If the thickness W3 of each of the shock absorbing layers 31 and 32 is greater than about 60 μm, the substrate 10 may be prone to curling.

The shock absorbing layers 31 and 32 may each include an aliphatic polyurea, which is an organic substance. The description of the polyurea of the shock absorbing layers 31 and 32 is the same as the description of the polyurea described above.

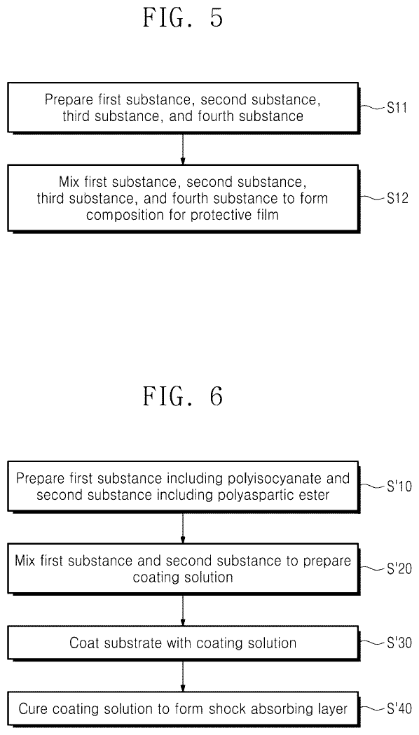

FIG. 4 and FIG. 5 are flowcharts showing a method for manufacturing a protective film according to an embodiment of the inventive concept. For simplicity of description, the descriptions provided with reference to FIG. 1 and FIG. 2 will be omitted.

Referring to FIG. 4, a method for manufacturing a film portion 21 according to an embodiment of the inventive concept may include forming a composition for a protective film (S10), coating the composition for a protective film (S20), and curing the coated composition for a protective film to provide the film portion 21 (S30).

Referring to FIG. 5, the forming of a composition for a protective film (S10) may include preparing a first substance, a second substance, a third substance, and a fourth substance (S11) and mixing the first substance, the second substance, the third substance, and the fourth substance to form the composition for a protective film (S12).

The first substance may include a first hollow particle, the second substance may include a polyisocyanate, the third substance may include a second hollow particle, and the fourth substance may include a polyaspartic ester. The first hollow particle, the polyisocyanate, the second hollow particle, and the polyaspartic ester may correspond to those described with reference to FIG. 1 and FIG. 2. The preparing of a first substance, a second substance, a third substance, and a fourth substance (S11) may include dispersing and dissolving each of the first substance, the second substance, the third substance, and the fourth substance in a solvent.

As an example, the solvent may be propylene glycol methyl ether acetate, isopropyl alcohol, or ethyl alcohol. The solvent may have both sufficiently high dispersibility for the first and second hollow particles and sufficiently high solubility for the polyisocyanate and the polyaspartic ester, and thus may prevent formation of precipitates.

Preparing the first substance including the first hollow particle may include adding a silane coupling agent to a colloidal solution in which the first hollow particle is dispersed in a solvent, thereby treating the surface of the first hollow particle. The first hollow particle and the silane coupling agent may have a weight ratio of 1:2 to 1:10.

Preparing the third substance including the second hollow particle may include adding a silane coupling agent to a colloidal solution in which the second hollow particle is dispersed in a solvent, thereby treating the surface of the second hollow particle. The second hollow particle and the silane coupling agent may have a weight ratio of 1:0.4 to 1:1.1.

The silane coupling agent may be chemically adsorbed on the surfaces of the first hollow particle and the second hollow particle. The silane coupling agent on the first hollow particle may be referred to as a first coupling compound, and the silane coupling agent on the second hollow particle may be referred to as a second coupling compound.

The mixing of the first substance, the second substance, the third substance, and the fourth substance to form the composition for a protective film (S12) may include performing the mixing by adjusting the weight ratio of the first substance and the third substance such that the weight ratio of the first hollow particle and the second hollow particle is about 1:1 to about 1:3.

The mixing of the first substance, the second substance, the third substance, and the fourth substance to form the composition for a protective film (S12) may include performing the mixing by adjusting the weight ratio of the first substance, the second substance, the third substance, and the fourth substance such that the weight of the first hollow particle is about 2 wt % to about 10 wt % based on the total solid content, i.e., the sum of the weights of the first hollow particle, the polyisocyanate, the second hollow particle, and the polyaspartic ester.

The above step may include performing the mixing by adjusting the weight ratio from the first substance to the fourth substance such that the equivalent ratio of an —NH or —C═N group of the first and second coupling compounds and an —NCO group of the polyisocyanate is 1:1 to 1:1.2. As a result of the mixing, the composition for a protective film may be formed.

Referring back to FIG. 4, the coating of the composition for a protective film (S20) may include coating the composition for a protective film on a substrate. As an example, the coating of the composition for a protective film may be performed by a slot-die coating, spray coating, or spin coating process. If the coating is performed by the above-described process, the composition for a protective film may be thinly and uniformly coated on a substrate 10.

The curing of the coated composition for a protective film to provide the film portion 21 (S30) may include performing a heat-treatment process on the composition for a protective film. The heat-treatment process may be performed at a pressure of about 0.1 Torr to about 760 Torr and a temperature of about 50° C. to about 80° C.

By the heat-treatment process, a solvent of the composition for a protective film may be dried and removed. The lower the boiling point of the solvent of the composition for a protective film and the lower the pressure of the heat-treatment process, the more effectively the solvent of the composition for a protective film may be dried even at a lower temperature. By the heat-treatment process, a urea bond may be formed between the —NH and —C═N groups in the silane coupling agent coated on the surface of the first hollow particle and the second hollow particle and in the polyaspartic ester and the —NCO group in the polyisocyanate. After the heat-treatment process is performed, the film portion 21 may be provided. The lower the temperature of the heat-treatment process, the occurrence of tensile stress and resulting curing may be reduced when the film portion 21 is provided.

FIG. 6 is a flowchart showing a method for manufacturing shock absorbing layers (31 and 32 of FIG. 3) according to an embodiment of the inventive concept. For simplicity of description, the descriptions provided with reference to FIG. 1 and FIG. 2 will be omitted.

Referring to FIG. 6, the method for manufacturing the shock absorbing layers (31 and 32 of FIG. 3) according to an embodiment of the inventive concept may include preparing a first substance including an polyisocyanate and a second substance including a polyaspartic ester (S′10), mixing the first substance and the second substance to prepare a coating solution (S′20), coating a substrate 10 with the coating solution (S′30), and curing the coating solution to form the shock absorbing layers (31 and 32) (S′40).

The preparing of a first substance including a polyisocyanate and a second substance including a polyaspartic ester (S′10) may include dissolving each of the polyisocyanate and the polyaspartic ester in a solvent. The solvent may be acetone. The solvent has advantages of having high solubility for the polyisocyanate and the polyaspartic ester and having a low boiling point.

The mixing of the first substance and the second substance to prepare a coating solution (S′20) may include performing the mixing by adjusting the weight ratio of the first substance and the second substance such that an equivalent ratio of an —NH group in the second substance and an —NCO group in the first substance is 1:1 to 1:1.2.

As an example, the coating of a substrate 10 with the coating solution (S′30) may be performed by a slot-die coating, spray coating, or spin coating process. The curing of the coating solution to form the shock absorbing layers (31 and 32) may include performing a heat-treatment process on the coating solution on the substrate 10. The heat-treatment process may be performed at a pressure of about 0.1 Torr to about 760 Torr and a temperature of about 35° C. to about 50° C.

According to an embodiment of the inventive concept, a film portion of a protective film includes first hollow particles dispersed in an organic compound, so that both visible light transmittance and haze performance may be improved. In addition, the surface of hollow silica is modified with a silane coupling agent, resulting in improving dispersibility in the organic compound, so that sparkling caused by agglomeration between the first hollow particles may be effectively suppressed. Furthermore, the organic compound and the first hollow particles are strongly bonded to each other through a urea reaction between an isocyanate group of an aliphatic polyisocyanate included in the organic compound and a secondary amine or imine group of the silane coupling agent, so that tensile strength and elongation rate may be effectively improved. Moreover, the film portion further includes second hollow particles having a relatively small size, so that dispersibility of the first hollow particles may be further improved, and surface hardness may also be improved. Finally, the organic compound further includes an aliphatic secondary polyamine, so that high hardness, high tensile strength, and high elongation may be effectively secured in an appropriate combination.

Although the embodiments of the inventive concept have been described above with reference to the accompanying drawings, the inventive concept may be implemented in other specific forms without changing the technical spirit or essential features of the inventive concept. Therefore, it is to be understood that the above-described embodiments are illustrative and non-limiting in every aspect.

What is claimed is:

1. A protective film comprising:
a substrate including a first surface and a second surface opposing each other; and
a film portion on the first surface,
wherein the film portion includes:
an organic compound including an aliphatic polyisocyanate; and
a first particle dispersed in the organic compound,
wherein the first particle includes:
a first hollow particle having an outer radius of 125 nm to 250 nm; and
a first coupling compound disposed on the surface of the first hollow particle, and having a secondary amine or imine group, and
the first particle and the organic compound are bonded through a urea reaction between the secondary amine or imine group and an isocyanate group.

2. The protective film of claim 1, wherein the organic compound further comprises a polyaspartic ester.

3. The protective film of claim 1, wherein the first hollow particle has a shell thickness of 20 nm to 50 nm.

4. The protective film of claim 1, wherein the first coupling compound comprises a compound of Formula 1 below or a compound of Formula 2 below:

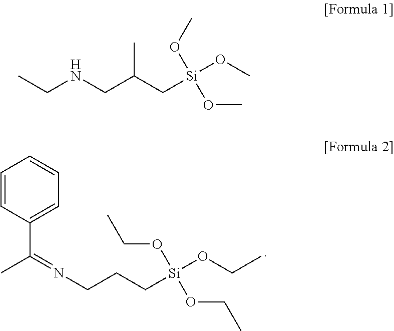

5. The protective film of claim 1, wherein the organic compound comprises an oligomer of hexamethylene diisocyanate.

6. The protective film of claim 1, wherein the organic compound comprises at least one of a compound of Formula 3 below, a compound of Formula 4 below, or a compound of Formula 5 below:

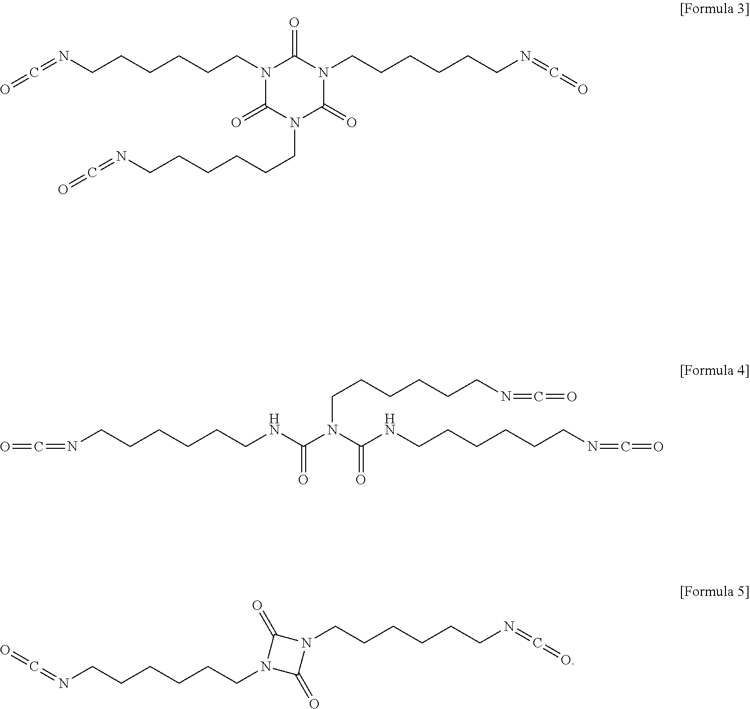 [SMILES: O=C=NCCCCCCn1c(=O)n(CCCCCCN=C=O)c(=O)n(CCCCCCN=C=O)c1=O ; O=C=NCCCCCCNC(=O)N(CCCCCCN=C=O)C(=O)NCCCCCCN=C=O ; O=C=NCCCCCCN1C(=O)N(CCCCCCN=C=O)C1=O]

7. The protective film of claim 1, wherein the first particle has a content of 2 wt % to 10 wt % based on 100 wt % of the film portion.

8. The protective film of claim 1, wherein the first hollow particle and the first coupling compound have a weight ratio of 1:2 to 1:10.

9. The protective film of claim 1, wherein the secondary amine or imine group of the first coupling compound and the isocyanate group of the aliphatic polyisocyanate have an equivalent ratio of 1:1 to 1:1.2.

10. The protective film of claim 1, wherein the film portion has a thickness of 1 μm to 7 μm.

11. The protective film of claim 1, wherein the film portion further comprises a second particle,
wherein the second particle includes:
a second hollow particle having an outer radius smaller than that of the first hollow particle; and
a second coupling compound disposed on the surface of the second hollow particle, and having a secondary amine or imine group; and
the second particle and the organic compound are bonded through a urea reaction between the secondary amine or imine group and an isocyanate group.

12. The protective film of claim 11, wherein the outer radius of the second hollow particle is 30 nm to 60 nm.

13. The protective film of claim 11, wherein the second hollow particle has a shell thickness of 10 nm to 20 nm.

14. The protective film of claim 11, wherein the second hollow particle and the second coupling compound have a weight ratio of 1:0.4 to 1:1.1.

15. The protective film of claim 11, wherein the first hollow particle and the second hollow particle have a weight ratio of 1:1 to 1:3.

16. The protective film of claim 11, wherein the first particle and the second particle comprise a hollow silica particle.

17. The protective film of claim 2, wherein the organic compound comprises a compound of Formula 6 below or a compound of Formula 7 below:

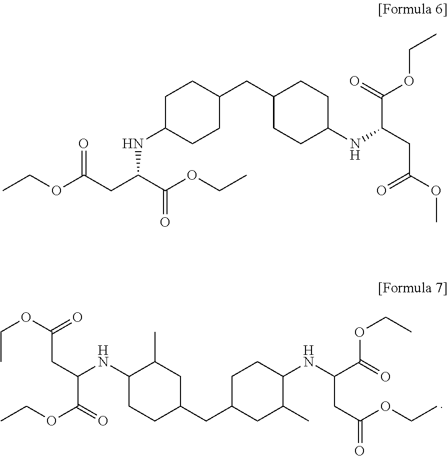

18. A protective film comprising:
a substrate including a first surface and a second surface opposing each other; and
a film portion on the first surface,
wherein the film portion includes:
an organic compound including an aliphatic polyisocyanate; and
a first particle and a second particle dispersed in the organic compound,
wherein the first particle includes:
a first hollow particle having an outer radius of about 125 nm to about 250 nm; and
a first coupling compound disposed on the surface of the first hollow particle, and having a secondary amine or imine group, and
the second particle includes:
a second hollow particle having an outer radius of 30 nm to 60 nm; and
a second coupling compound disposed on the surface of the second hollow particle, and having a secondary amine or imine group, and
the first particle and the second particle and the organic compound are bonded through a urea reaction between the secondary amine or imine group and an isocyanate group, and
the film portion has a thickness of 1 μm to 7 μm.

19. A protective film comprising:
a substrate including a first surface and a second surface opposing each other;
a film portion on the first surface;
a first shock absorbing layer disposed on the first surface of the substrate, and interposed between the film portion and the substrate; and
a second shock absorbing layer on the second surface of the substrate,
wherein the film portion includes:
an organic compound including an aliphatic polyisocyanate; and
a first particle dispersed in the organic compound,
wherein the first particle includes:
a first hollow particle having an outer radius of 125 nm to 250 nm; and
a first coupling compound disposed on the surface of the first hollow particle, and having a secondary amine or imine group, and
the first particle and the organic compound are bonded through a urea reaction between the secondary amine or imine group and an isocyanate group.

20. The protective film of claim 19, wherein the film portion further comprises a second particle,
wherein the second particle includes:
a second hollow particle having an outer radius smaller than that of the first hollow particle; and
a second coupling compound disposed on the surface of the second hollow particle, and having a secondary amine or imine group, and
the second particle and the organic compound are bonded through a urea reaction between the secondary amine or imine group and an isocyanate group.
